(19) United States
(12) Patent Application Publication
(10) Pub. No.: US 2008/0298908 A1
(43) Pub. Date: Dec. 4, 2008

(54) Pipeline for the Hydraulic or Pneumatic Transport of Solids

(76) Inventor: Alexander Esser, Warstein (DE)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 12/159,815

(22) PCT Filed: Oct. 13, 2006
(86) PCT No.: PCT/DE2006/001822

§ 371 Date: Jul. 1, 2008

(30) Foreign Application Priority Data
Jan. 9, 2006 (DE) 102006001315.8

(51) Int. Cl. B65G 53/52; F16L 57/06; F16L 43/00

(52) U.S. Cl. 406/191

(57) ABSTRACT

A pipeline (1) comprises straight pipe pieces (2) and curved pipe bends (3) having each an inner pipe (5; 22), an outer pipe (6; 23) and terminal, double-layer coupling flanges (7; 16, 17) composed of inner wear rings (8; 18, 19) and outer ring collars (9; 20, 21) with coupling grooves (10). Pipe pieces (2) and/or pipe bends (3) which follow one another in sections are detachably coupled by split couplings (4) that act as rotating joints and pipe connectors. The wear rings (19) in the coupling flanges (17) of the pipe bends (3) on the outlet side have different wall thicknesses about the circumference, while the wear rings (18) in the coupling flanges (16) at the inlet side and in the coupling flanges (7) of the pipe pieces (2) have a uniform wall thickness about their circumference. The wall thickness of the wear rings (19) in the coupling flanges (17) of the pipe bends (3) at the outlet end is sized greater in the circumferential sections distal to the centers of curvature (28) of the pipe bends (3) than in the circumferential sections closer to the centers of curvature (28).

The invention relates to a pipeline for hydraulically or pneumatically transporting solids according to the features in the preamble of claim 1.

A pipeline of a type involved here finds wide application in particular as concrete-distribution rig in cooperation with a mobile concrete pump. An essential criterion of such pipelines is their reach in height, their reach in width, the type of folding as well as in particular the number of cantilever arms.

Practical experience has shown that in the case of a standardized inner transport cross section and resultant predefined outer configurations and dimensions of the coupling flanges, the wear volume of wear rings integrated in coupling flanges of pipe bends at hand cannot be maintained sufficiently large for all solids to be transported or being transported in order to prevent wear that can be encountered on the inlet side of straight pipe pieces attached to pipe bends.

To overcome this problem, DE 195 00 953 C1 proposes to provide the wear rings with regions of greater wall thicknesses which in relation to the pipe bend axes are located distal to the centers of curvature of the middle pipe portions between the terminal coupling flanges, compared to the regions closer to the centers of curvature. The greater wall thicknesses of the wear rings were hereby suited to the wall thicknesses of the middle pipe portions in the adjacent end portions.

This known proposal has been proven successful in practice because the service life of the pipe bends is significantly longer compared to pipe bends of DE 40 10 556 A1 for example.

In particular the practical application of the pipelines as concrete-distribution rigs has also shown that wearing remains a problem in the area of two successive pipe bends, especially when angled by 90° in opposite directions, as well as in the attached pipe pieces. Such a successive configuration of pipe bends and pipe pieces is, however, necessary when collapsing a concrete-distribution rig for relocation from one job site to another. As a consequence of the deflection of the solids by 2×90°, the peripheral region with greatest wall thickness of a wear ring abuts precisely the peripheral region of thinnest wall thickness of the following pipe bend because of the eccentricity of the wear rings caused by the different wall thickness, when two pipe bends are coupled. As the clearance necessarily increases in the coupling zone of two pipe bends and/or one pipe bend and a pipe piece during the course of operation as a result of the comparably frequent rotations of the split couplings and the resultant wear of the parts in the area of the split couplings, the clearance steadily increases within the coupling zones. This fact ultimately causes a progressive increase in the offset of the wall thickness of the wear rings in the transition zone from one pipe bend to the following pipe bend or a pipe piece, leading to even greater wear.

Starting from the state of the art, the invention is based on the object to provide a pipeline for hydraulically or pneumatically transporting solids to significantly extend the service life also in the area of successive pipe bends which can be hingedly coupled with one another as well as with adjacent pipe pieces.

The solution of this object is set forth by the features of claim 1.

An important fact of the configuration according to the invention is the establishment of a precisely predefined transport direction for the pipe bends integrated in the pipeline. This may, for example, be ensured by providing the pipe bends with a respective identification, such as an arrow for example, which cannot be easily removed from the pipe bends.

Within the scope of the invention, the wear rings in the coupling flanges of the pipe pieces as well as the wear rings in the coupling flanges of the pipe bends on the inlet side for the solids in transport direction have a uniform wall thickness about the entire circumference. The length axes of the wear rings extend hereby in coaxial relationship to the length axes of the pipe pieces and the pipe bend axes. Conversely, the wear rings in the coupling flanges of the pipe bends on the outlet side for the solids in transport direction have varying wall thicknesses as viewed about their circumference. The wall thicknesses are configured such that they are greater in relation to the pipe bend axes in the peripheral regions distal to the centers of curvature of the pipe bends than in the peripheral regions closer to the centers of curvature. As a result, the length axes of the inner cross sections of the wear rings in the coupling flanges on the outlet side are arranged at an offset to the length axes of the outer cross sections of the wear rings in direction to the centers of curvature. In other words, centered wear rings are provided in the coupling flanges of the pipe bends and the pipe pieces on the inlet side and eccentric wear rings are provided in the coupling flanges on the outlet side.

These measures according to the invention have the advantage that a wear ring of varying wall thicknesses about the circumference on the outlet side of a pipe bend abuts upon a pipe bend with a wear ring which has a uniform wall thickness as viewed about the circumference. In this way, the regions exposed to high wear on the outlet side of a pipe bend can be conformed in every relative position substantially to the adjoining wear zones of a pipe bend or a pipe piece.

The effect of these measures is a longer service life of the entire pipeline which can be assessed higher by about 30% in comparison to the conventional pipeline. A concrete-distribution rig can thus be used significantly more cost-effective.

The features set forth in claim 2 have the positive effect that the wear rings in the coupling flanges on the inlet side are virtually removed from the primary wearing zone. Wear is limited substantially to the wear rings in the coupling flanges on the outlet side. As the sections of the wear rings in closer proximity to the centers of curvature of the pipe bends are subject anyway to significantly less wear than in the sections distal to the centers of curvature, minimal inner wear edges on the wear rings of the coupling flanges on the inlet side pose no obstacle.

The features of claim 3 ensure a reliable flow behavior of the solids by coaxially aligning the length axes of the inner cross sections of the wear rings in the coupling flanges on the outlet side of the pipe bends with the length axes of the inner pipes of the pipe bends.

The features of claim 4 even further enhance the wear behavior of the wear rings in the coupling flanges of the pipe bends on the outlet side.

The wall thicknesses of the wear rings in the coupling flanges of the pipe bends on the inlet side ensure in accordance with claim 5 sufficiently large wall thicknesses of the outer ring collars with the coupling grooves provided there.

As a consequence of the features of claim 6, it is possible to extend the outer pipes of the pipe bends to the ring collars of the adjacent coupling flanges so that according to the features of claim 7 the outer pipes of the pipe bends can be welded with the terminal ring collars of their coupling flanges. For that purpose, it is possible to provide the ring collars with suitable annular centering seats for the outer pipes.

A further advantage of the invention, as set forth in claim 8, is the manufacture of the outer pipes of the pipe bends of steel sheet and the inner pipes of cast steel, with the wall thicknesses of the inner pipes being sized greater than the wall thicknesses of the outer pipes.

The inner pipes of the pipe bends can then be embedded reliably in the outer pipes, when in accordance with the features of claim 9 the inner pipes are arranged at a radial distance to the outer pipes, with the gap between the inner pipes and the outer pipes being filled with concrete.

As a result of the features of claim 10, the ring collars of the coupling flanges of the pipe pieces span over the outer pipes of the pipe pieces. The ring collars are then advantageously welded by a fillet weld with the outer surfaces of the outer pipes.

It is further of advantage to dimension in accordance with claim 11 the wall thicknesses of the wear rings in the coupling flanges of the pipe pieces greater than the wall thicknesses of the steel sheet inner pipes of the pipe pieces.

In this context, the sum of the wall thicknesses of the inner pipes and outer pipes of the pipe pieces correspond according to claim 12 to about the wall thicknesses of the wear rings in the coupling flanges of the pipe pieces.

The invention will now be described in greater detail with reference to the drawings, in which:

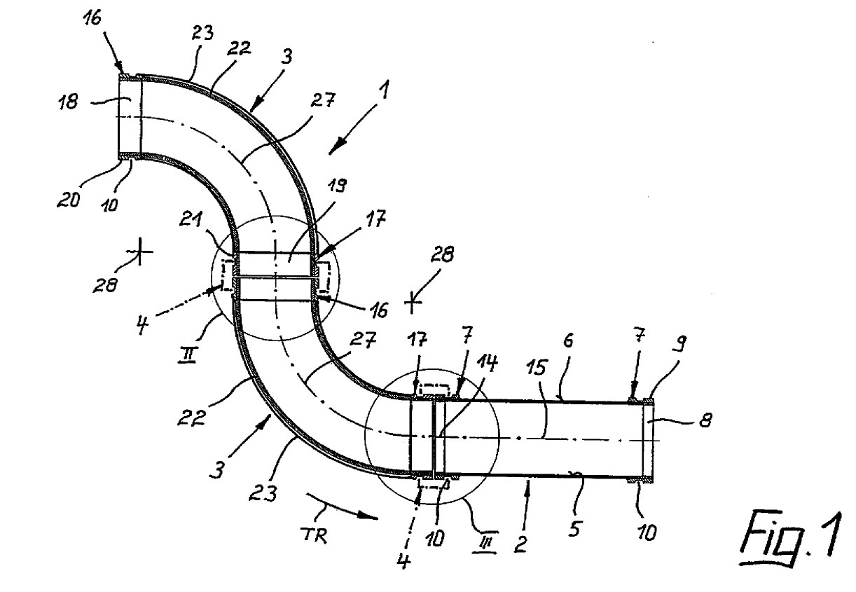

FIG. 1 shows a vertical longitudinal section of a length portion of a pipeline;

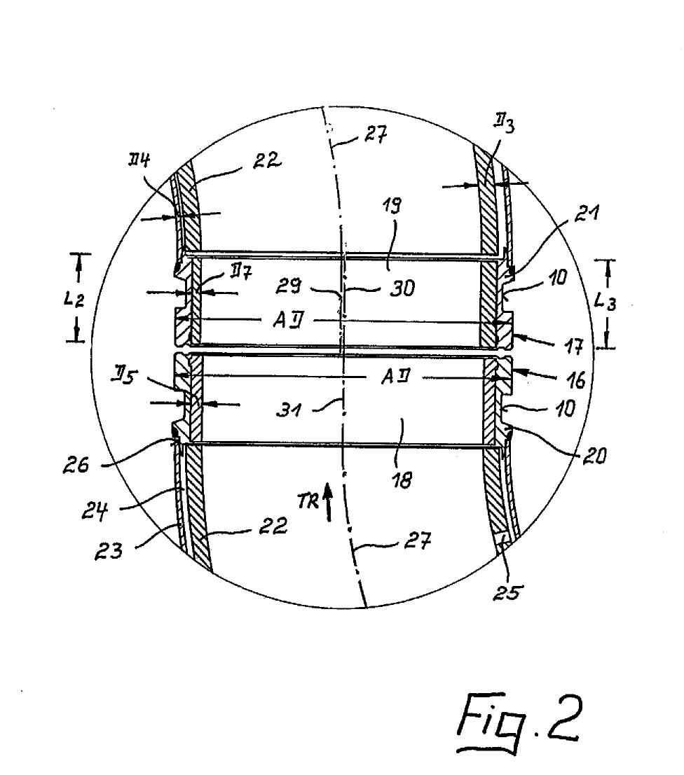

FIG. 2 shows the cutaway II of FIG. 1 on an enlarged scale, and

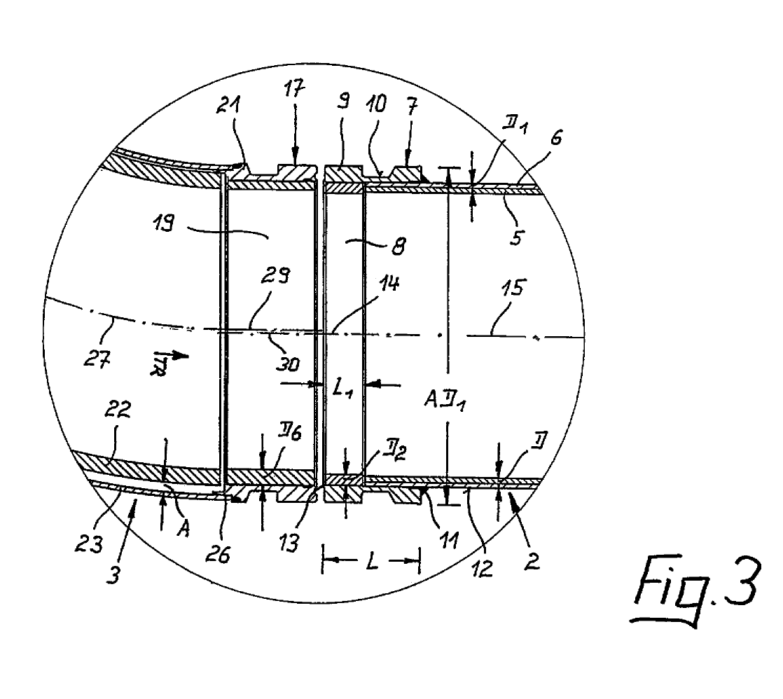

FIG. 3 shows the cutaway III of FIG. 1, also on an enlarged scale.

1 designates in FIG. 1 a length portion of a pipeline for hydraulically or pneumatically transporting solids, such as, for example, concrete. Such a pipeline 1 is used for example in combination with a mobile concrete pump as jointly foldable concrete-distribution rig. The pipeline 1 has a predefined transport direction designated by the arrow TR.

The pipeline 1, which can have lengths of more than 60 m, is comprised of straight pipe pieces 2 as well as pipe bends 3 which have a 90° curvature. Such a configuration of the pipe bends 3 allows connection of two successive pipe bends 3 or of a pipe bend 3 with a pipe piece 2 not only with the aid of split couplings, shown only schematically, but also permits relative rotations of the pipe pieces 2 and the pipe bends 3 within the split couplings. In this way, a long pipeline 1 can be folded together so as to be transportable from one job site to another on a movable base.

The pipe pieces 2 are comprised (see FIGS. 1 and 3) of an inner pipe 5 of steel sheet, an outer pipe 6 of steel sheet as well as terminal coupling flanges 7. The wall thickness D of the inner pipes 5 is greater than the wall thickness D1 of the outer pipes 6.

The coupling flanges 7 are made of inner wear rings 8 as well as outer ring collars 9 with coupling grooves 10. The axial length L of the ring collars 9 is sized greater than the axial length L1 of the wear rings 8. In this way, the inner pipes 5 and the outer pipes 6 engage in the ring collars 9. The ring collars 9 are welded by fillet welds with the outer surfaces 12 of the outer pipes 6.

The position of the wear rings 8 in the coupling flanges 7 is secured by protrusion 13 on the end face of the ring collars 9.

As is further shown in FIGS. 1 and 3, the length axes 14 of the wear rings 8 in the coupling flanges 7 extend coaxial with the length axes 15 of the pipe pieces 2.

Finally, FIG. 3 shows also that the wear rings 8 in the coupling flanges 7 of the pipe pieces 2 have wall thicknesses D2 which are uniform about the entire circumference and sized greater than the wall thicknesses D of the inner pipes 5, with the sum of the wall thicknesses D and D1 of the inner pipes 5 and outer pipes 6 substantially corresponding to the wall thicknesses D2 of the wear rings 8.

FIGS. 2 and 3 show in particular that the coupling flanges 16 of the pipe bends 3 on the inlet side and the coupling flanges 17 on the outlet side have inner wear rings 18, 19 and outer ring collars 20, 21 with coupling grooves 10. The axial length L3 of the wear rings 18, 19 is sized substantially the same as the axial length L2 of the ring collars 20, 21. The outer diameters AD of the ring collars 20, 21 on the coupling flanges 16, 17 of the pipe bends 3 correspond to the outer diameters AD1 of the ring collars 9 of the pipe pieces 2.

Inner pipes 22 of cast steel and outer pipes 23 of steel sheet extend between the coupling flanges 16, 17 of the pipe bends 3. The wall thickness D3 of the inner pipes 22 are sized greater than the wall thickness D4 of the outer pipes 23. As the outer pipes 23 are arranged at a distance A to the inner pipes 22, a gap 24 is formed between the inner pipes 22 and the outer pipes 23 and filled during operation of the pipeline 1 with a solid material, like concrete for example. For that purpose, radially directed openings 25 are provided in the inner pipes 22 for introduction of the solid material into the gap 24.

The outer pipes 23 can be secured by providing the ring collars 20, 21 of the coupling flanges 16, 17 with annular centering elements 26. The outer pipes 23 are welded to the ring collars 20, 21 in these regions.

The wear rings 8 in the coupling flanges 7 of the pipe pieces 2 as well as the wear rings 18 in the coupling flanges 16 of the pipe bends 3 on the inlet side in transport direction TR of the solids have a uniform wall thickness D2 and D5, respectively, about the entire circumference. The length axes 31 of the wear rings 18 extend coaxial to the pipe bend axes 27 (FIG. 2).

The wear rings 19 in the coupling flanges 17 of the pipe bends 3 on the outlet side in transport direction TR have about their circumference varying wall thicknesses which are sized, in relation to the pipe bend axes 27, greater in the peripheral sections that are distal to the centers of curvature 28 of the pipe bends 3 than in the peripheral sections that are closer to the centers of curvature 28. The length axes 29 of the inner cross sections of the wear rings 19 in the coupling flanges 17 of the pipe bends 3 on the outlet side are arranged in eccentric offset relationship to the length axes 30 of the outer cross sections of the wear rings 19 in the direction to the centers of curvature 28.

The greatest wall thicknesses D6 of the wear rings 19 in the coupling flanges 17 of the pipe bends 3 on the outlet side are sized greater and the smallest wall thicknesses D7 are sized smaller than the wall thicknesses D2 of the wear rings 8 in the coupling flanges 7 of the pipe pieces 2 as well as D5 of the wear rings 18 in the coupling flanges 16 on the inlet side of the pipe bends 3. The length axes 29 of the inner cross sections of the wear rings 19 in the coupling flanges 17 on the outlet side are hereby in coaxial alignment to the length axes 27 of the inner pipes 21 of the pipe bends 3.

FIGS. 2 and 3 further show that the greatest wall thicknesses D6 of the wear rings 19 correspond in the coupling flanges 17 on the outlet side substantially to the wall thicknesses D3 of the inner pipes 22 of the pipe bends 3. Conversely, the wall thicknesses D5 of the wear rings 18 in the coupling flanges 16 of the pipe bends 3 on the inlet side are sized smaller than the wall thicknesses D3 of the inner pipes 22 of the pipe bends 3.

### LIST OF REFERENCE SIGNS

1—pipeline
2—pipe pieces
3—pipe bends
4—split couplings
5—inner pipe of 2
6—outer pipe of 2
7—coupling flanges of 2
8—wear rings in 7
9—ring collars of 7
10—coupling flanges in 9
11—fillet welds
12—outer surfaces of 6
13—protrusions on 9
14—length axes of 8
15—length axes of 2
16—coupling flanges of 3 on the inlet side
17—coupling flanges of 3 on the outlet side
18—wear rings in 16
19—wear rings in 18
20—ring collars on 16
21—ring collars on 17
22—inner pipes of 3
23—outer pipes of 3
24—gap between 22 and 23
25—openings in 22
26—centering elements on 20, 21
27—pipe bend axes
28—centers of curvature of 3
29—length axes of the inner cross sections of 19
30—length axes of the outer cross sections of 19
31—length axes of 18
A—distance of 22 and 23
AD—outer diameter of 20, 21
AD1—outer diameter of 9
D—wall thickness of 5
D1—wall thickness of 6
D2—wall thickness of 8
D3—wall thickness of 22
D4—wall thickness of 23
D5—wall thickness of 18
D6—greatest wall thickness of 19
D7—smallest wall thickness of 19
L—length of 9
L1—length of 8
L2—length of 20 21
L3—length of 18, 19
TR—transport direction (arrow)

1.-12. (canceled)

13. A pipeline for hydraulically or pneumatically transporting solids, comprising:
plural pipe members selected from the group consisting of a straight pipe piece and a curved pipe bend, each pipe member including an inner pipe, an outer pipe in surrounding relationship to the inner pipe, and a double-layer coupling flange positioned on each end face of the pipe member and having an inner wear ring and an outer ring collar disposed in surrounding relationship to the inner wear ring and formed with a coupling groove; and
a split coupling constructed as a rotating joint for detachably coupling successive pipe members,
wherein the wear ring of the coupling flange of the pipe piece and the wear ring of the coupling flange of the pipe bend on an inlet side in a transport direction of the solids have a uniform wall thickness about the entire circumference,
wherein the wear ring is defined by a length axis which extends coaxial to a length axis of the pipe member,
wherein the wear ring of the coupling flange of the pipe bend on an outlet side in the transport direction of the solids has a varying wall thickness about its circumference;
wherein the wear ring of the coupling flange of the pipe bend on an outlet side has a wall thickness which in relation to a pipe bend axis is sized greater in a peripheral section distal to a center of curvature of the pipe bend than in a peripheral section that is closer to the center of curvature; and
wherein the wear ring of the coupling flange of the pipe bend on the outlet side has an inner cross section which is defined by a length axis arranged in eccentric offset relationship to a length axis of an outer cross section of the wear ring in a direction of the center of curvature.

14. The pipeline of claim 13, wherein the wear ring of the coupling flange of the pipe bend on the outlet side has a greatest wall thickness, which is greater than a wall thickness of the wear ring of the coupling flanges of the pipe piece as well as the wear ring of the coupling flange of the pipe bend on the inlet side, and a smallest wall thickness, which is smaller than the wall thickness of the wear ring in the coupling flange of the pipe piece as well as the wear ring in the coupling flange of the pipe bend on the inlet side.

15. The pipeline of claim 13, wherein the length axis of the inner cross section of the wear ring of the coupling flange of the pipe bend on the outlet side is disposed in coaxial alignment to a length axis of the inner pipe of the pipe bend.

16. The pipeline of claim 14, wherein the greatest wall thickness of the wear ring of the coupling flange of the pipe bend on the outlet side substantially corresponds to a wall thickness of the inner pipe of the pipe bend.

17. The pipeline of claim 13, wherein a greatest wall thickness of the wear ring of the coupling flange of the pipe bend on the inlet side is sized smaller than a wall thickness of the inner pipe of the pipe bend.

18. The pipeline of claim 13, wherein the ring collar of the coupling flange of the pipe bend is defined by an axial length which substantially corresponds to the axial length of the wear ring received in the ring collar.

19. The pipeline of claim 13, wherein the outer pipe of the pipe bend is welded with the ring collar of the coupling flange of the pipe bend.

20. The pipeline of claim 13, wherein the outer pipe of the pipe bend is made of steel sheet and defined by a wall thickness, and wherein the inner pipe is made of cast steel and defined by a wall thickness, wherein the wall thickness of the inner pipe is sized greater than the wall thickness of the outer pipe.

21. The pipeline of claim 13, wherein the inner pipe of the pipe bend is spaced from the outer pipe by a radial distance to form a gap between the inner pipe and the outer pipe, said gap being filled with solid material.

22. The pipeline of claim 21, wherein the solid material is concrete.

23. The pipeline of claim 13, wherein the wear ring of the coupling flange of the pipe piece has an axial length which is about half a length of the ring collar, wherein the ring collar is welded with an outer surface of the outer pipe of the pipe piece.

24. The pipeline of claim 13, wherein the wall thickness of the wear ring of the coupling flange of the pipe piece is sized greater than a wall thickness of the inner pipe of the pipe piece.

25. The pipeline of claim 13, wherein the inner pipe of the pipe piece has a wall thickness and the outer pipe of the pipe piece has a wall thickness, wherein a sum of the wall thicknesses of the inner pipe and the outer pipe of the pipe piece substantially corresponds to a wall thickness of the wear ring of the coupling flange of the pipe piece.
